(19) United States
(12) Patent Application Publication
(10) Pub. No.: US 2008/0240157 A1
(43) Pub. Date: Oct. 2, 2008

(54) RECEIVED FRAME PROCESSING DEVICE, RECEIVED FRAME PROCESSING SYSTEM AND RECEIVED FRAME PROCESSING METHOD

(75) Inventors: Takanobu Muraguchi, Tokyo (JP); Fumio Sudo, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/056,537

(22) Filed: Mar. 27, 2008

(30) Foreign Application Priority Data
Mar. 30, 2007 (JP) 2007-094209

(51) Int. Cl. H04J 3/22

(52) U.S. Cl. 370/470

(57) ABSTRACT

A received frame processing device that receives a frame of variable length from a network, and transfers the frame to a buffer group that is provided on a system memory and is a common area to a CPU, wherein a buffer includes a plurality of buffers. And a second frame is transferred to a first buffer when the second frame is received before a given amount of time has elapsed after a first frame has been transferred to the first buffer, on the other hand, the second frame is transferred to a second buffer after the ownership of the first buffer has been transferred to the CPU when the second frame is received after the first frame has been transferred to the first buffer and after a given amount of time or longer has elapsed.

### CROSS REFERENCE TO RELATED APPLICATION

This application is based upon and claims the benefit of priority from the prior Japanese Patent Application No. 2007-94209 filed on Mar. 30, 2007; the entire contents of which are incorporated herein by this reference.

### BACKGROUND OF THE INVENTION

1. Field of the Invention

The present invention relates to a received frame processing device, a received frame processing system and a received frame processing method, and in particular, to a received frame processing device, a received frame processing system and a received frame processing method that handle a frame of variable length received from a network.

2. Description of the Related Art

In communication schemes such as Ethernet (registered trademark), IEEE 1394 and USB, communication is performed by sending and receiving data on a frame of variable length basis. Generally, a scheme is used in which, when a computer system (hereinafter referred to simply as a system) captures data from a network, received frames are temporarily stored in buffers, which are provided on a system memory, and necessary frames are read out from the buffers in accordance with a predetermined rule.

Conventional typical buffer management methods include a management method by which only one frame is stored in one buffer (hereinafter referred to as an unpacking mode), and a management method by which one or more frames are stored in one buffer (hereinafter referred to as a packing mode).

With a conventional unpacking mode, each buffer stores only one frame but not the next frame even if free space is left therein. Accordingly, there is a problem that the usage efficiency of a buffer memory is reduced.

Even with the conventional unpacking mode, by reducing the size of a buffer, the usage efficiency of the buffer memory can be improved. However, since reducing the size of the buffer increases the number of buffers, another problem arises that a buffer management area becomes larger.

On the other hand, with a conventional packing mode, one buffer stores one or more frames. Therefore, a buffer storing a frame is not released (ownership is not transferred to the system side) if there is sufficient free space. Accordingly, there is a problem, in particular, that when the interval between frame receptions is long, a delay time from when a frame is received to when the frame is handled (hereinafter referred to as latency) increases.

Even with the conventional packing mode, latency can be reduced by performing time-out processing on the system side, and, at the point of time when frame reception has not occurred for a given amount of time, ignoring the ownership of a buffer and forcibly read the contents of a frame stored in the buffer. In this case, however, a time-out mechanism needs to be prepared on the system side, and the portion of the frame that has been read from a buffer which ownership has not been obtained needs to be memorized on the system side.

In addition, when ownership is transferred to the system side next time, and the same buffer is read, processing such as skip is needed for frames that have already been read. Although latency can be reduced even in the packing mode by reading the buffer from the system side regardless of the ownership of the buffer, the processing on the system side becomes complex, which gives rise to another problem.

Furthermore, with a conventional buffer management technique, when notifying the system of the arrival of frames by generating interrupts, an interrupt is often generated for each frame. When an interrupt is generated every time a frame is received, there is also a problem that as the frequency of frame reception is increased, the frequency of interrupt generation is increased, and a CPU load is also increased.

Further, conventionally, as a received frame processing device that handles a frame of variable length, a received frame processing device has been proposed in which a plurality of buffers which have different lengths are provided, and the buffers are switched depending on the length of the frame received (see, e.g., Japanese Patent Laid-Open No. 2002-185466).

According to the proposal described in Japanese Patent Laid-Open No. 2002-185466, on the assumption that one frame is stored in one buffer, the length of a frame to be received is predicted to prepare the appropriate length and the number of buffers, beforehand. However, when the length of the frame actually received and the length of the buffer prepared are considerably different, for example, despite predicting the reception of long frames and preparing multiple long buffers, when multiple short frames are received, the short frames are stored in the long buffers, which is a problem of the buffer memory usage efficiency being reduced. Further, there is a problem that since the number of the buffers increases when many short buffers are prepared, a memory area configured to store information on the buffers to manage the buffers increases.

In addition, when continuous frames having different sizes are received, positions of each stored frame are distributed over discrete places on a system memory. There is a problem that, when the frames are distributed over discrete places on the system memory, as compared with a case where frames are continuously arranged on the system memory, the cache of the CPU does not function efficiently, and a CPU load is increased. In addition, there is a problem that a mechanism to select a buffer having a suitable size among empty buffers is needed.

### SUMMARY OF THE INVENTION

A received frame processing device according to an embodiment of the present invention that receives a frame of variable length from a network, and transfers the frame to a buffer area that is provided on a system memory and is a common area to a CPU, wherein the buffer area includes a plurality of buffers. And a second frame is transferred to a first buffer when the second frame is received before a given amount of time has elapsed after a first frame has been transferred to the first buffer, on the other hand, the second frame is transferred to a second buffer after the ownership of the first buffer has been transferred to the CPU when the second frame is received after the first frame has been transferred to the first buffer and after a given amount of time or longer has elapsed.

### BRIEF DESCRIPTION OF THE DRAWINGS

FIG. 1 is a block diagram illustrating the configuration of a received frame processing device 1 according to embodiments of the present invention;

FIG. 2 is a schematic diagram illustrating the configuration of a system memory 4;

FIG. 3 is a diagram illustrating the concrete example of buffer management information when a frame has a fixed length;

FIG. 4 is a diagram illustrating the concrete example of buffer management information when a frame has a variable length and a storage mode is an unpacking mode;

FIG. 5 is a diagram illustrating the concrete example of buffer management information when a frame has a variable length and a storage mode is a packing mode;

FIG. 6 is a flowchart illustrating the processing procedure of a received frame according to a first embodiment of the present invention;

FIG. 7 is a time chart illustrating an example of status in which frames are being received from a network 2;

FIG. 8 is a schematic diagram illustrating storage positions when the received frames are stored in a buffer group 42;

FIG. 9 is a schematic diagram illustrating storage positions when all the received frames are stored in the buffer group 42 in the unpacking mode;

FIG. 10 is a schematic diagram illustrating storage positions when all the received frames are stored in the buffer group 42 in the packing mode;

FIG. 11 is a time chart illustrating the latency of a frame 0 in the packing mode;

FIG. 12 is a time chart illustrating the latency of the frame 0 according to the embodiment;

FIG. 13 is a schematic diagram illustrating an example in which a received frame is stored spanning a plurality of buffers;

FIG. 14 is a flowchart illustrating the processing procedure of a received frame according to a second embodiment of the present invention;

FIG. 15 is a flowchart illustrating the processing procedure of a received frame according to a third embodiment of the present invention;

FIGS. 16A and 16B are flowcharts illustrating the processing procedure of a received frame according to a fifth embodiment of the present invention; and

FIG. 17 is a flowchart illustrating the processing procedure of a received frame according to a sixth embodiment of the present invention.

### DETAILED DESCRIPTION OF THE PREFERRED EMBODIMENTS

Embodiments of the present invention will now be described with reference to the drawings.

### First Embodiment

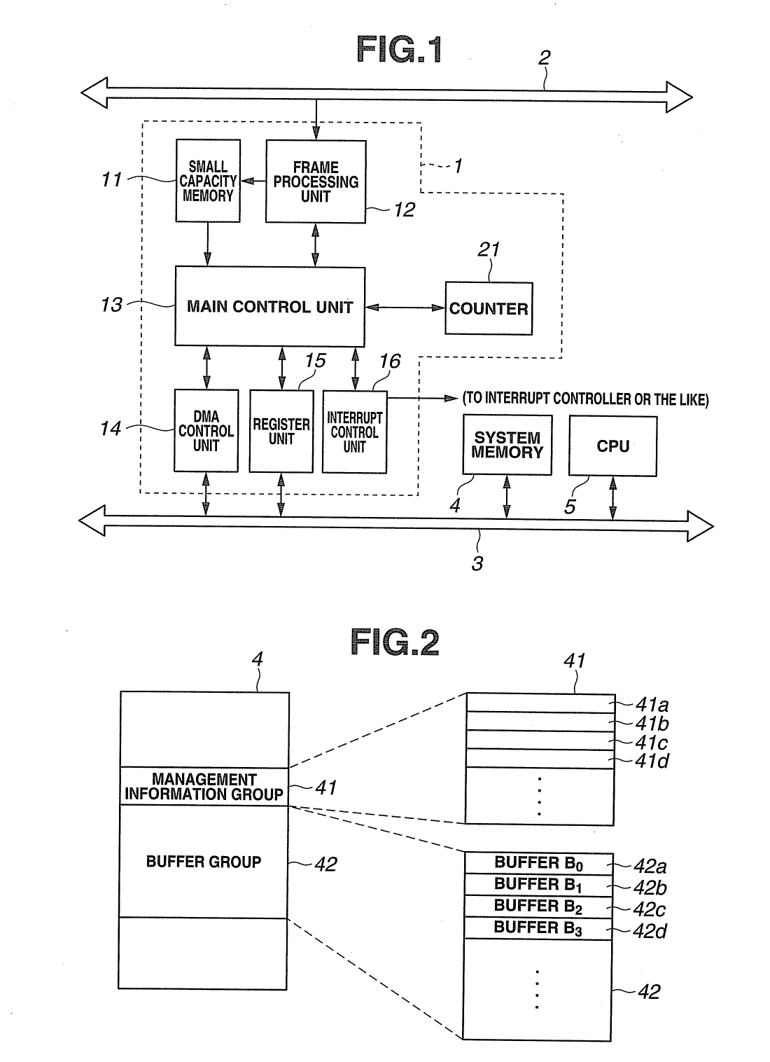

First, the configuration of a received frame processing device 1 according to a first embodiment of the present invention will be described with reference to the drawings. FIG. 1 is a block diagram illustrating the configuration of the received frame processing device 1 according to embodiments of the present invention.

The received frame processing device 1 of the present embodiment is electrically connected to a network 2 configured to use a communication scheme such as Ethernet (registered trademark) to communicate a frame of variable length, and a system bus 3 configured to send and receive data to and from a computer system. A system memory 4 configured to store frames and various types of data received from the network 2 through the received frame processing device 1, and a CPU 5 configured to use these frames and data to perform various types of processing are also connected to the system bus 3.

In the received frame processing device 1, frames received the network 2 are temporarily stored in a small capacity memory 11 through a frame processing unit 12. The small capacity memory 11 is generally configured in FIFO or the like, and mainly used as a buffer configured to perform burst transfer (a transfer method by which frames are sent to the system bus 3 continuously) to the system memory 4 through the system bus 3. Even if there are frames received from the network 2, when the system bus 3 is busy, the frames cannot be immediately transferred to the system memory 4. In such a case, the frames are temporarily stored in the small capacity memory 11, and then burst transfer is performed.

Further, since a clock (operating frequency) of the network 2 is often different from that of the system bus 3, the small capacity memory 11 is also used as a buffering memory configured to exchange frames between different clock domains.

Frames received from the network 2 are output to the frame processing unit 12, in which the frames are analyzed to detect and measure the length and interval of the frames. Note that frames stored in the small capacity memory 11 may be directly received from the network 2, not through the frame processing unit 12.

Information on a frame analyzed in the frame processing unit 12 is output to a main control unit 13. The main control unit 13 determines a storage method of frames in the system memory 4, based on information on frames obtained, in particular, the frame length and the interval between frame receptions, and various types of control information and status information stored in a register unit 5. That is to say, the main control unit 13 determines whether the next outgoing frame is to be stored in the same buffer as that of the frame output immediately before, or stored in another buffer. Note that a counter 21 is also connected to the main control unit 13, and is used for measurement of the interval between frame receptions.

Based on the determined frame storage method, the main control unit 13 outputs the frames that are temporarily stored in the small capacity memory 11 to a predetermined buffer in the system memory 4 through a DMA control unit 14 and the system bus 3.

An interrupt control unit 16 is also connected to the main control unit 13. The interrupt control unit 16 is connected to an interrupt controller or the like, which is not shown, and notifies the CPU 5 that an interrupt occurred, through the interrupt controller at a predetermined timing. Note that, sometimes, the CPU 5, which has an interrupt controller built in, is notified of the occurrence of an interrupt directly, and not through the interrupt controller, which is not shown.

As shown in FIG. 2, an area for a buffer group 42 in which frames received from the received frame processing device 1 are stored, and an area for a buffer management information group 41 in which information on the buffer group 42 is stored are reserved in advance in the system memory 4. FIG. 2 is a schematic diagram illustrating the configuration of the system memory 4. Note that the areas for the buffer management information group 41 and the buffer group 42 are shared between the received frame processing device 1 and the CPU 5.

The buffer group 42 includes a plurality of buffers 42a to 42d, each of the buffers storing frames received from the received frame processing device 1. The buffer management information group 41 includes buffer management information 41a to buffer management information 41d, i.e., the same number of buffers as the buffer group 42 contains, and various types of information on the corresponding buffers 42a to 42d (ownership, storage mode, position of the stored frame) are stored in each of the buffer management information 41a to the buffer management information 41d.

Here, the ownership of a buffer is information indicating which of the received frame processing unit 1 and the CPU 5 has the access right (update right) to a corresponding buffer. The side that has the ownership of the buffer has the access right (update right) to the buffer and the corresponding buffer management information, and the ownership is transferred to the other side when processing on the buffer and the buffer management information has been completed. In this manner, the received frame processing device 1 and the CPU 5 send and receive information to and from each other through the system memory 4.

Further, a storage mode is information indicating which of a mode in which a plurality frames can be stored in a corresponding buffer (hereinafter referred to as a packing mode), and a mode in which only one frame can be stored in the buffer (hereinafter referred to as an unpacking mode) is to be used.

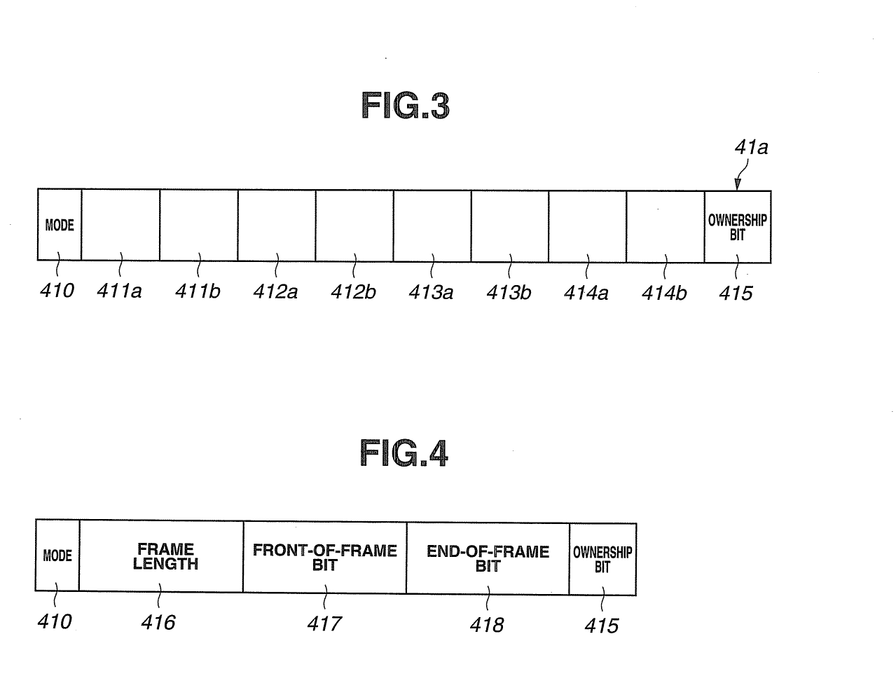

Although various methods can be used to represent the buffer management information 41a, the buffer management information 41a can be concretely represented as follows. First, a case where all the received frames have a fixed length, and are stored in different portions as offset values will be described with reference to FIG. 3. FIG. 3 is a diagram illustrating the concrete example of buffer management information when a frame has a fixed length. FIG. 3 shows a case where up to four frames can be stored in one buffer.

First, mode information 410, which indicates whether the storage mode of the corresponding buffer 42a is a packing mode or an unpacking mode, is written into the front. Then, for the frame stored in the buffer 42a, a start offset value 411a and an end offset value 411b are written. When a plurality of frames are stored, start offset values 412a, 413a and 414a, and end offset values 412b, 413b and 414b for each frame are written in order in which the frames were stored. Finally, an ownership bit 415, which indicates which of the received frame processing device 1 and the CPU 5 has the ownership of the corresponding buffer 42a, is written.

Note that a mechanism is provided to indicate that, when the number of frames stored in the buffer 42a is two or three, no frame is stored thereafter. For example, a predetermined value such as 0 is written into the start offset value of the portion where no frame is stored (the start offset value 413a of the third frame when the number of frames stored is two, the start offset value 414a of the fourth frame when the number of frames stored is three).

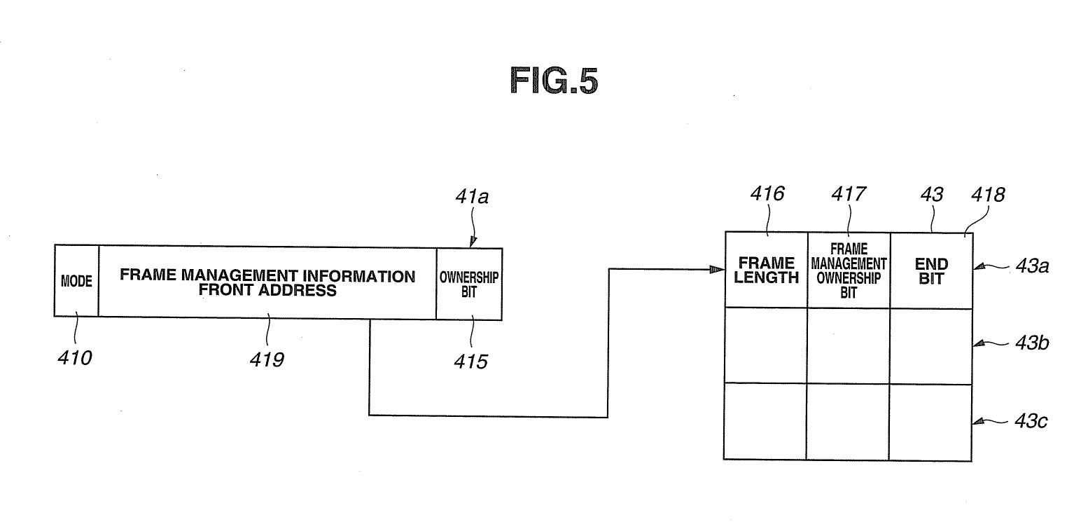

Next, a case where a received frame has a variable length will be described with reference to FIGS. 4 and 5. FIG. 4 is a diagram illustrating the concrete example of buffer management information when a frame has a variable length and a storage mode is an unpacking mode, and FIG. 5 is a diagram illustrating the concrete example of buffer management information when a frame has a variable length and a storage mode is a packing mode.

When a storage mode is an unpacking mode, and only one frame is stored in the corresponding buffer 42a, mode information 410, which indicates that the storage mode of the corresponding buffer 42a is an unpacking mode, is written into the front of the buffer management information 41a, as shown in FIG. 4. Then, the frame length 416 of the frame stored in the buffer 42a is written.

In addition, a front-of-frame bit 417, which indicates whether or not the front portion of the frame is included, and an end-of-frame bit 418, which indicates whether or not the end portion of the frame is included, are written. When the length of the frame is longer than that of the buffer, the frame is stored in a plurality of buffers. However, since the CPU 5 must access the entire frame when using the frame to perform processing, the CPU 5 refers to the front-of-frame bit 417 and the end-of-frame bit 418 to identify the buffer in which the frame has been stored.

For example, when both of the front-of-frame bit 417 and the end-of-frame bit 418 are ON, it is identified that the whole of one frame has been stored in the buffer 42a. On the other hand, for example, when the front-of-frame bit 417 is ON, and the end-of-frame bit 418 is OFF, it is identified that a portion of the frame has been stored in the buffer 42a, and the remaining portion of the frame has been stored in the following buffers 42b or in the following buffers 42b and on.

In the buffer management information 41a, the ownership bit 415, which indicates where the ownership of the buffer 42a is, is written.

When the storage mode is a packing mode, and a plurality of frames might have been stored in the corresponding buffer 42a, an area in which the frame management information group 43 is stored is provided in the system memory 4. Information on the buffer 42a is stored in the buffer management information 41a and the frame management information group 43 as shown in FIG. 5.

The mode information 410, which indicates that the storage mode of the corresponding buffer 42a is an unpacking mode, is written into the front of the buffer management information 41a. Then, in the frame management information 43, in order to identify a position into which information on the frame stored in the buffer 42a has been written, a front address 419 (hereinafter referred to as frame information front address) of the frame management information group 43 is written.

FIG. 5 shows an example in which three frames of variable length have been stored in the corresponding buffer 42a, each frame being stored in the frame management information group 43 as frame management information 43a to frame management information 43c. In this case, the front address of the frame management information 43a is written into the frame information front address 419 of the buffer management information 41a.

A stored frame length 416, a frame management ownership bit 417, which indicates which of the received frame processing device 1 and the CPU 5 has the ownership of the frame management information, and an end bit 418, which indicates whether or not the frame is the last frame stored in the buffer 42a, are written into the frame information 43a to frame information 43c. In the example shown in FIG. 5, since three frames have been stored in the buffer 42a, OFF is written into the end bit 418 of the frame information 43a and the frame information 43b, and ON is written into the end bit of the frame information 43c.

The ownership bit 415, which indicates where the ownership of the buffer 42a is, is written into the end of the buffer management information 41a.

Note that, even in an unpacking mode, buffer management information as shown in FIG. 5 can be used. For example, when the buffer 42a is in the unpacking mode, and stores a frame of variable length, the stored frame length 416, the frame management ownership bit 417, which indicates which of the received frame processing device 1 and the CPU 5 has the ownership of the frame management information, and the end bit 418, which indicates whether or not the frame is the last frame stored in the buffer 42a, are written into the frame information 43a. In the example shown in FIG. 5, since one frame has been stored in the buffer 42a, ON is written into the end bit of the frame information 43a.

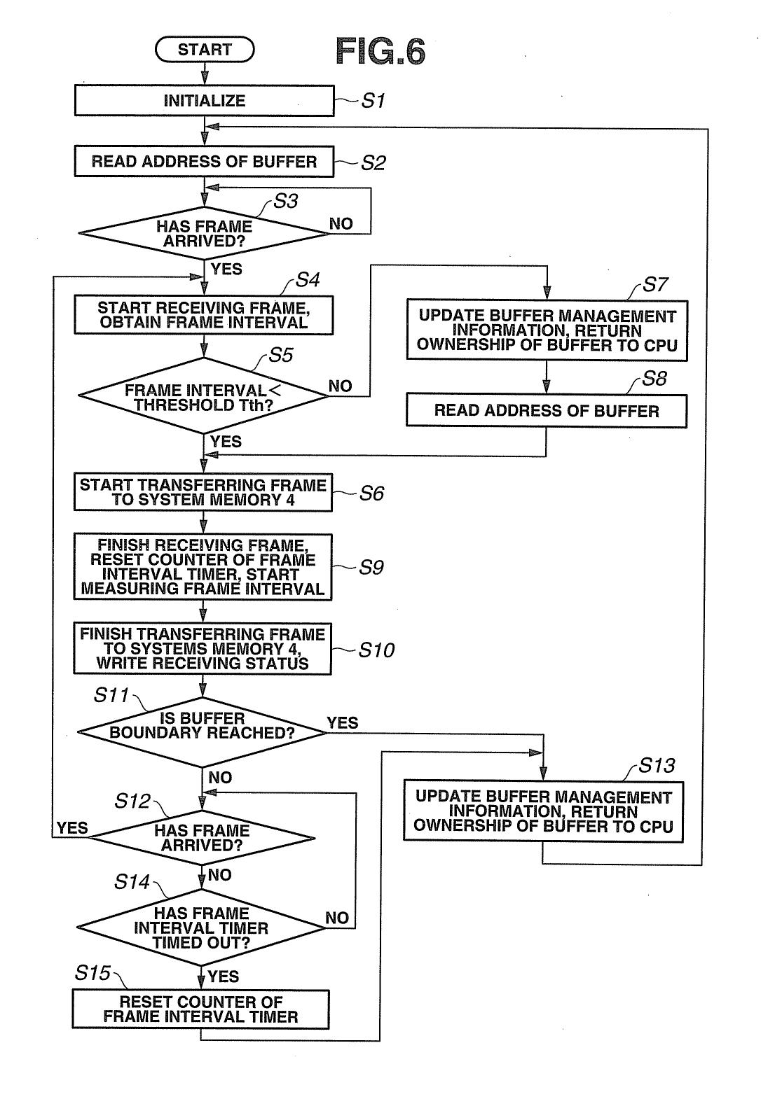

Next, a received frame processing method in the received frame processing device 1 described above (a method of storing received frames in the buffer group 42) will be described with reference to FIG. 6. FIG. 6 is a flowchart illustrating the processing procedure of a received frame according to the first embodiment of the present invention.

First, each portion of the received frame processing device 1 is initialized in step S1. As a specific operation of this initialization, for example, the operation whereby various settings are written by the CPU 5 can be cited.

Note that simultaneously to this step S1, the CPU 5 reserves areas from the system memory 4 for the buffer group 42 and buffer management information group 41, and sets ownership to the received frame processing device 1. At the point of time when this operation and writing of each setting have been completed, the CPU 5 writes into a given location in a register unit 15, thereby sending the received frame processing device 1a signal to start the operation. The received frame processing device 1, which has received the signal to start the operation, resets a counter 21 or the like by the main control unit 13, to start the operation.

Next, in step S2, first buffer management information 41a from the buffer management information group 41 in the system memory 4 is referred to obtain the address of the corresponding buffer 42a. Then, in step S3, the arrival of frames from the network 2 is waited for.

When the frames arrive, this process goes to step S4, to start frame reception. In the present step, the received frames are written successively into the small capacity memory 11. The time interval between the frame and the frame received immediately before (hereinafter referred to as the previous frame) (more specifically, time from when the reception of the previous frame ended to when the reception of the frame started, hereinafter referred to as a frame interval) is calculated by the frame processing unit 12. Note that when the frame is a first frame that has been received from the network 2, and there is not the previous frame, the frame interval is zero.

Next, the process goes to step S5, where the main control unit 13 compares the frame interval calculated in step S4 with a preset threshold Tth. Here, the threshold Tth is a value used to switch the storage mode of received frames, and determined from the network speed, the minimum frame gap of the network, the frame size for which the processing load of the CPU 5 per time unit is greatest, processing time of the CPU 5 and the like. The threshold Tth is stored in the register unit 15 or the like, and can be reset as needed.

In step S5, when the frame interval is determined to be less than the threshold Tth, the main control unit 13 determines that the received frames are stored in the packing mode. In this case, the process goes to step S6, where the transfer of the received frames to a buffer that has obtained an address as storage destination of frames is started. More specifically, according to the control by the main control unit 13, the frames written into the small capacity memory 11 are output to the system bus 3 through the DMA control unit 14, and written into a buffer prepared on the system memory 4.

Note that the present step is usually performed while the small capacity memory 11 is receiving frames from the network 2. That is to say, while receiving frames from the network 2, the small capacity memory 11 successively outputs the received frames to the system bus 3 through the main control unit 13 and the DMA control unit 14.

On the other hand, in step S5, when the frame interval is determined to be equal to or higher than the threshold Tth, the main control unit 13 determines that the received frames are stored in the unpacking mode. In this case, the process goes to step S7, where the necessary portions of the buffer management information 41a are updated, and the ownership is returned to the CPU 5. Then, the process goes to step S7, where the next buffer management information 41b from the buffer management information group 41 in the system memory 4 is referred to obtain the address of the corresponding buffer 42b, then the process goes to step S6.

In step S6, frame transfer to a suitable buffer in the system memory 4 is started, and when a predetermined time has elapsed, writing of frames from the network 2 into the small capacity memory 11 finishes (step S9). In step S9, in order to measure the frame interval between the frame and the frame that arrives immediately after the frame (hereinafter referred to as the next frame), at the point of time when the reception of the frames at the small capacity memory 11 has been completed, a counter for a frame interval timer provided on the counter 21 is reset by the main control unit 13, and the measurement of the frame interval is started immediately.

Then, in step S10, when the transfer of frames to the suitable buffer in the system memory 4 has been completed, receiving status (information for determining that frames have been successfully transferred, an error occurred while transferring a frame, or the like) is written into the buffer management information corresponding to a buffer in which the frames have been stored.

Then, in step S11, it is determined whether or not there is free space in the buffer into which the frame has been written. In step S11, when it is determined that a buffer boundary is not reached, and there is free space in the buffer, the process goes to step S12, where the arrival of the next frame is waited for.

On the other hand, in step 11, when it is determined the buffer boundary is reached, and there is not free space in the buffer, the process goes to step S13, where the necessary portions of the buffer management information corresponding to the buffer are updated, and the ownership is returned to the CPU 5. Then, the process returns to step S2, where the next buffer management information from the buffer management information group 41 in the system memory 4 is referred to obtain the address of the corresponding buffer, and the arrival of the next frame is waited for.

In step S12, when frames arrive, the process returns to step S4, where frame reception is started. On the other hand, when no frame arrived, the process goes to step S14, where it is determined whether or not a frame interval timer, which has started measurement in step S9, has timed out. More specifically, the value of the frame interval timer at that time is compared with the threshold value Tth, and when the timer value is equal to or higher than the threshold Tth, it is determined that a time is out.

When the interval between frame receptions received from the network 2 is long, if frames are stored in a buffer in a packing mode, the latency of a frame is reduced, because the ownership of the buffer is not transferred to the CPU 5 until the memory of the buffer has been used up. Then, the frame interval timer is used to generate a sign as a timeout when any frame has not been received for a given amount of time, transferring the ownership of the buffer to the CPU 5 to improve the latency of the frame.

In step S14, when it is determined that the frame interval timer has not timed out, the process returns to step S12, where the arrival of the next frame is waited for. On the other hand, in step S14, when it is determined that the frame interval timer has timed out, the process goes to step S15, where the counter for the frame interval timer is reset by the main control unit 13. Then, the process goes to step S13, where the necessary portions of the buffer management information corresponding to the buffer are updated, and the ownership is returned to the CPU 5.

While the received frame processing device 1 is operating, the processes of steps S2 to S15 described above are repeatedly performed, and the frames received from the network 2 are written into suitable buffers in the buffer group 42 in the system memory 4.

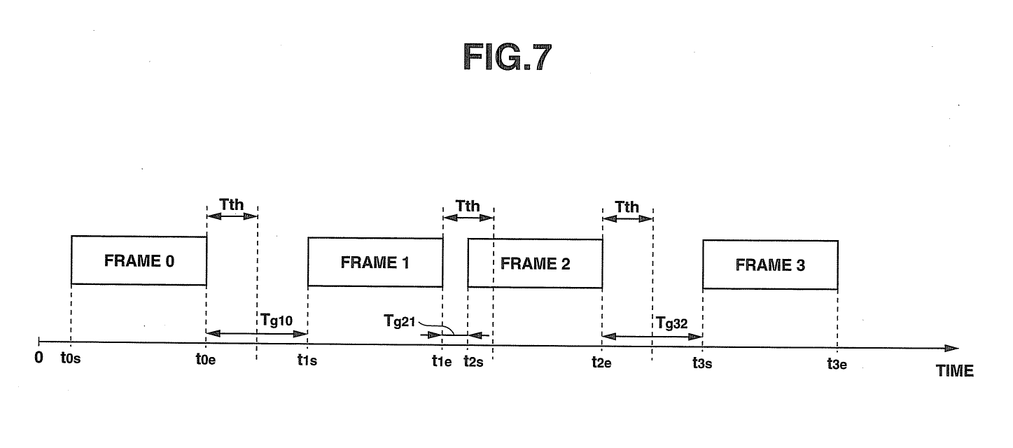

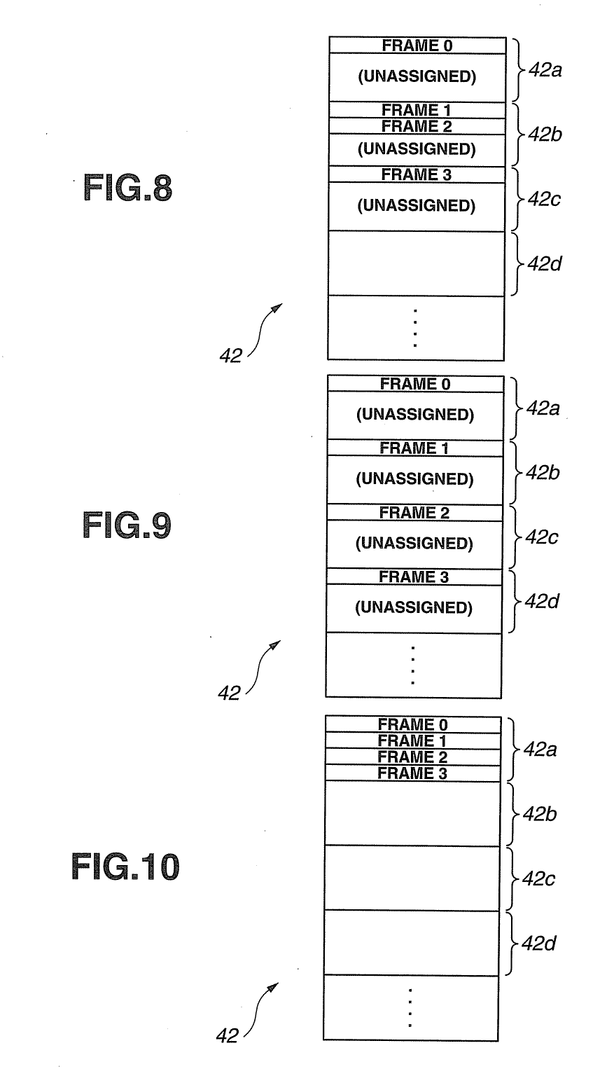

The received frame processing method, which has been described with reference to the flowchart in FIG. 6, will be described in more detail with reference to concrete examples shown in FIGS. 7 and 8. FIG. 7 is a time chart illustrating an example of status in which frames are being received from the network 2. In FIG. 7, a horizontal axis indicates elapsed time t from when the received frame processing device 1 has started operating. In addition, FIG. 8 is a schematic diagram illustrating storage positions when the received frames are stored in a buffer group 42.

First, when the received frame processing device 1 starts operating, and an initiation is completed (step S1), first buffer management information 41a from the buffer management information group 41 in the system memory 4 is referred to obtain the address of the corresponding buffer 42a as the storage destination of the first frame (step S2). Then, in step S3, the arrival of frames from the network 2 is waited for.

When a frame 0 arrives at the received frame processing device 1, and the reception is started at time t₀ₛ in step S4, the frame interval is measured. Since the frame 0 is a first frame that arrives at the received frame processing device 1, and there is not the previous frame, the frame interval is zero. Next, in step S5, the frame interval (=zero) calculated in step S4 is compared with the preset threshold Tth.

Here, since 0<Tth, the process goes to step S6, where the transfer of the received frame 0 to the buffer 42a that has obtained the address as the storage destination of the frame is started. When the predetermined time has elapsed and time toe is reached, the reception of the frame 0 from the network 2 finishes (step S9).

In step S9, in order to measure the frame interval (=T_{g10}) between the frame (=frame 0) and the next frame (=frame 1), the counter for the frame interval timer provided on the counter 21 is reset by the main control unit 13, and the measurement of the frame interval is started immediately.

Then, in step S10, when the transfer of the frame 0 to the buffer 42a has finished, receiving status is written into the buffer management information 41a. Then, in step S11, it is determined whether or not there is free space in the buffer 42a into which the frame 0 has been written. In the example of FIG. 7, since there is free space in the buffer 42a even after the frame 0 has been stored therein, as shown in FIG. 8, the process goes to step S12, where the arrival of the next frame (=frame 1) is waited for.

Since the next frame (=frame 1) does not arrive soon in the example of FIG. 7, the process goes to step S14 to determine whether or not the frame interval timer, which has started measurement in step S9, has timed out. In the example of FIG. 7, since the frame 1 does not arrive even when Tth has elapsed from when the reception of the frame 0 has finished, it is determined that the frame interval timer has timed out at the point of time t=t₀ₑ+Tth, and the process goes to step S15, where the counter for the frame interval timer is reset by the main control unit 13. Then, the process goes to step S13, where the necessary portions of the buffer management information 41a are updated, and the ownership of the buffer 42a is returned to the CPU 5.

Then, the process returns to step S2, where the next buffer management information 42b from the buffer management information group 41 is referred to obtain the address of the buffer 42b as the storage destination of the next frame (=frame 1), and the arrival of the next frame is waited for (step S3).

When a frame 1 arrives at the received frame processing device 1, and the reception is started at time t₁ₛ in step S4, the frame interval is measured. Although the frame interval between the frame 1 and the previous frame (=frame 0) is T_{g10}, the counter for the frame interval timer is reset in step S15, therefore, the frame interval is zero.

Next, in step S5, the frame interval (=zero) calculated in step S4 is compared with the preset threshold Tth. Here, since 0<Tth, the process goes to step S6, where the transfer of the received frame 1 to the buffer 42a that has obtained the address as the storage destination of the frame is started. When the predetermined time has elapsed and time t₁ₑ is reached, the reception of the frame 1 from the network 2 finishes (step S9).

In step S9, in order to measure the frame interval (=T_{g21}) between the frame (=frame 1) and the next frame (=frame 2), the counter for the frame interval timer provided on the counter 21 is reset by the main control unit 13, and the measurement of the frame interval is started immediately.

Then, in step S10, when the transfer of the frame 1 to the buffer 42b has finished, receiving status is written into the buffer management information 41b. Then, in step S11, it is determined whether or not there is free space in the buffer 42b into which the frame 1 has been written. In the example of FIG. 7, since there is free space in the buffer 42b even after the frame 1 has been stored therein, as shown in FIG. 8, the process goes to step S12, where the arrival of the next frame (=frame 2) is waited for.

Since the next frame (=frame 2) does not arrive soon in the example of FIG. 7, the process goes to step S14, where it is determined whether or not the frame interval timer, which started measurement in step S9, has timed out. In the example of FIG. 7, since the frame 2 arrives before Tth has elapsed after the reception of the frame 1 has finished (t₂ₛ<t₁ₑ+Tth), the process goes to step S12 and step S4 from step S14.

When a frame 2 arrives at the received frame processing device 1, and the reception is started at time t2, in step S4, the frame interval T_{g21} is measured. Next, in step S5, the frame interval T_{g21} calculated in step S4 is compared with the preset threshold Tth. Here, since T_{g21}<Tth, the process goes to step S6, where the transfer of the received frame 2 to the buffer 42b that has obtained the address as the storage destination of the frame is started. That is to say, the frame 2 and the frame 1 are stored in the same buffer 42b.

When the predetermined time has elapsed and time t₂ₑ is reached, the reception of the frame 2 from the network 2 finishes (step S9). In step S9, in order to measure the frame interval (=T_{g32}) between the frame (=frame 2) and the next frame (=frame 3), the counter for the frame interval timer provided on the counter 21 is reset by the main control unit 13, and the measurement of the frame interval is started immediately.

Then, in step S10, when the transfer of the frame 2 to the buffer 42b has finished, receiving status is written into the buffer management information 41b. Then, in step S11, it is determined whether or not there is free space in the buffer 42b into which the frame 2 has been written. In the example of FIG. 7, since there is free space in the buffer 42b even after the frame 2 has been stored therein, as shown in FIG. 8, the process goes to step S12, where the arrival of the next frame (=frame 3) is waited for.

Since the next frame (=frame 3) does not arrive immediately in the example of FIG. 7, the process goes to step S14 to determine whether or not the frame interval timer, which has started measurement in step S9, has timed out. In the example of FIG. 7, since the frame 3 does not arrive even when Tth has elapsed from when the reception of the frame 2 has finished, it is determined that the frame interval timer has timed out at the point of time t=t₂ₑ+Tth, and the process goes to step S15, where the counter for the frame interval timer is reset by the main control unit 13. Then, the process goes to step S13, where the necessary portions of the buffer management information 41b are updated, and the ownership of the buffer 42b is returned to the CPU 5.

Then, the process returns to step S2, where the next buffer management information 42c from the buffer management information group 41 is referred to obtain the address of the buffer 42c as the storage destination of the next frame (=frame 3), and the arrival of the next frame is waited for (step S3).

When a frame 3 arrives at the received frame processing device 1, and the reception is started at time t₃, in step S4, the frame interval is measured. Although the frame interval between the frame 3 and the previous frame (=frame 2) is T_{g32}, the counter for the frame interval timer is reset in step S15, therefore, the frame interval is zero.

Next, in step S5, the frame interval (=zero) calculated in step S4 is compared with the preset threshold Tth. Here, since 0<Tth, the process goes to step S6, where the transfer of the received frame 3 to the buffer 42c that has obtained the address as the storage destination of the frame is started. When the predetermined time has elapsed and time t₃ₑ is reached, the reception of the frame 3 from the network 2 finishes (step S9).

In step S9, in order to measure the frame interval between the frame (=frame 3) and the next frame, the counter for the frame interval timer provided on the counter 21 is reset by the main control unit 13, and the measurement of the frame interval is started immediately.

Then, in step S10, when the transfer of the frame 3 to the buffer 42c has finished, receiving status is written into the buffer management information 41c. Then, in step S11, it is determined whether or not there is free space in the buffer 42c into which the frame 3 has been written. In the example of FIG. 7, since there is free space in the buffer 42c even after the frame 3 has been stored therein, as shown in FIG. 8, the process goes to step S12, where the arrival of the next frame is waited for.

In this manner, while the received frame processing device 1 is being operated, the processes of steps S2 to S15 described above are repeatedly performed, and the frames received from the network 2 are written into suitable buffers in the buffer group 42 in the system memory 4. That is to say, in the example of FIG. 7, the frame 0 and the frame 3 are stored in the buffer 42a and the buffer 42c, respectively, in the unpacking mode, and the frames 1 and 2 are stored in the buffer 42b in the packing mode (see FIG. 8).

As shown in FIG. 9, when all the frames 0 to 3 have been stored in the buffers 42a to 42d in the unpacking mode, the sum total of the unassigned memory areas in which no frame has been stored in the used buffers (=buffers 42a to 42d) is larger than the sum total of the unassigned memory areas in which no frame has been stored in the used buffers (=buffers 42a to 42c) according to the present embodiment, as shown in FIG. 8. FIG. 9 is a schematic diagram illustrating storage positions when all the received frames are stored in the buffer group 42 in the unpacking mode.

Accordingly, it can be seen that the memory usage efficiency in the received frame processing device 1 of the present embodiment is improved more than a conventional received frame processing device in which frames are stored in buffers in an unpacking mode.

On the other hand, as shown in FIG. 10, when all the frames 0 to 3 are stored in the buffers 42a in the packing mode, the sum total of the unassigned memory areas in which no frame has been stored in the used buffer (=buffer 42a) is smaller than the sum total of the unassigned memory areas in which no frame has been stored in the used buffers (=buffers 42a to 42c) according to the present embodiment, as shown in FIG. 8. FIG. 10 is a schematic diagram illustrating storage positions when all the received frames are stored in the buffer group 42 in the unpacking mode.

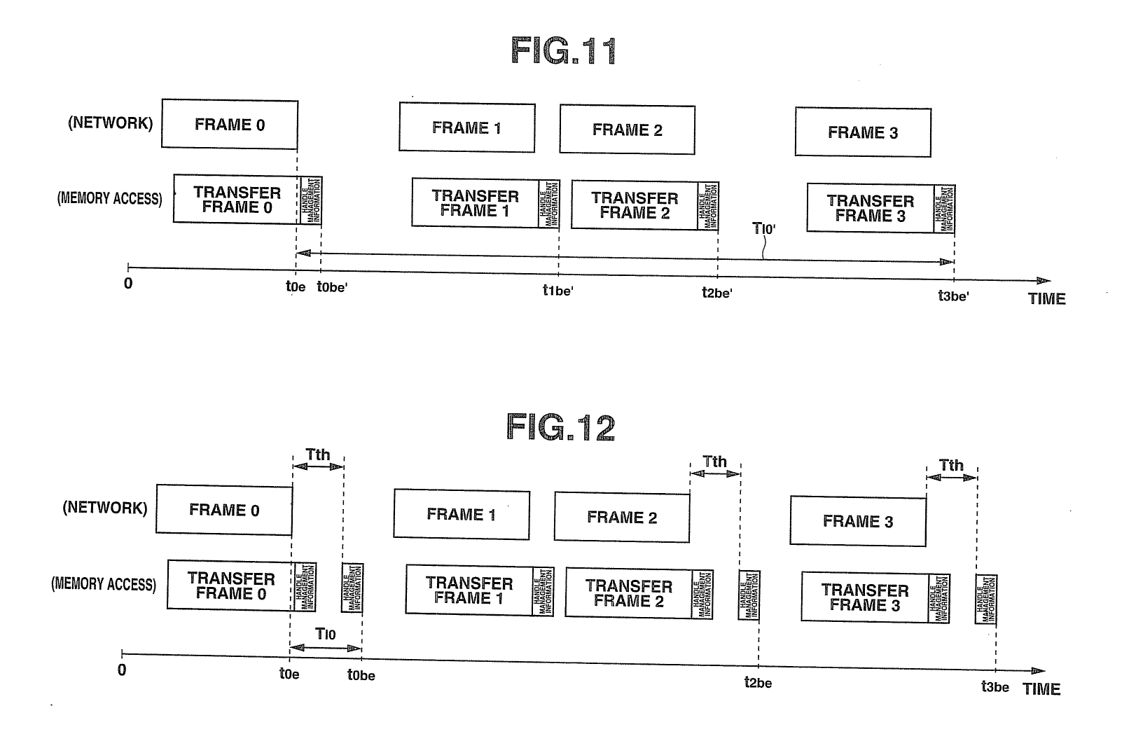

Here, with reference to FIGS. 11 and 12, the received frame processing device 1 according to the present embodiment is compared with a conventional received frame processing device in which all frames are stored in the buffer group 42 in the packing mode from the viewpoint of latency.

FIG. 11 is a time chart illustrating the latency of the frame 0 in the packing mode. FIG. 12 is a time chart illustrating the latency of the frame 0 according to the present embodiment. Here, latency means time from when the reception of the end of the frame at the small capacity memory 11 has been completed to when the copy of all the frames to the system memory 4 has been completed, and the ownership of the buffer has been transferred to the CPU 5 (from the viewpoint of the movement of the ownership, the latency also means time from when the transfer of all frames to the system memory 4 has been completed to when the ownership of the buffer has been moved to the CPU 5).

In FIGS. 11 and 12, the timing of writing frames into the small capacity memory 11 of the received frame processing device 1 from the network 2 is shown in the upper column, and the timing of writing frames and various types of information into the buffer management information group 41 and the buffer group 42 in the system memory 4 from the received frame processing device 1 is shown in the lower column.

As shown in FIG. 11, since, when all frames are stored in the buffer group 42 in the packing mode, all of four frames, the frame 0 to frame 3, are written into one buffer 42a, the ownership of the buffer 42a is not transferred to the CPU 5 until the writing of the frame 3 finishes. Accordingly, the latency T_{10′} of the frame 0 is the time elapsed from the point of time (=t₀ₑ) when the small capacity memory 11 has finished receiving the frame 0 from the network 2, to the point of time (=t_{3be}) when the frame 3 has been written from the received frame processing device 1 into the buffer 42a, information such as receiving status has also been written into the corresponding frame management information 41a, and the ownership of the buffer 42a has been transferred to the CPU 5.

On the other hand, in the present embodiment, the frame 0 is written into the buffer 42a in the unpacking mode, and subsequent frames of the frame 1 are written into other buffers 42b and 42c. Accordingly, as shown in FIG. 12, the latency T₁₀ of the frame 0 is the time elapsed from the point of time (=t₀ₑ) when the small capacity memory 11 has finished receiving the frame 0 from the network 2 to the point of time (=t_{0be}) when the ownership of the buffer 42a has been transferred to the CPU 5.

Thus, it can be seen that T₁₀<T_{10′}, and the latency of the received frame processing device 1 of the present embodiment is smaller than that of the conventional received frame processing device in which frames are stored in buffers in the packing mode. Further, since the latency does not depend on only the sizes of the buffers 42a to 42d, the sizes of the buffers 42a to 42d can be increased to reduce the number of buffers included in the buffer group 42. Accordingly, since the amount of the buffer management information included in the buffer management information group 41 is also reduced, the memory area allocated to the buffer management information group 41 can be reduced, and the memory usage efficiency can be improved.

Furthermore, since, when frames are stored in the packing mode, the amount of the frame management information is larger than when the frames are stored in the unpacking mode, the processing amount of the CPU 5 is increased, and the load is increased. Since the packing mode and the unpacking mode are included in the received frame processing device 1 of the present embodiment, the CPU load can be reduced more than that when all processing is performed in the packing mode.

In this manner, in the present embodiment, since frames are stored in the packing mode when the interval between frame arrivals is shorter than a preset threshold Tth, and in the unpacking mode when the interval between frame arrivals is longer, the memory usage efficiency can be improved more that when all the frames were stored in the unpacking mode, and the memory usage efficiency can be also improved more that when all the frames were stored in the packing mode, thereby reducing the frame latency, and the CPU load.

Note that in the present embodiment, it has been explained that, when the reception of frames from the network 2 has been completed, processing is performed in order in which information such as receiving status is written into the frame management information, and then the address of the buffer into which the next frame will be written is read out, however, the order may be reversed so that the address of the buffer is read out and then the information such as the receiving status is written.

### Second Embodiment

Next, a received frame processing device according to a second embodiment of the present invention will be concretely described.

Although in the first embodiment described above, when the frame interval between one frame and the next frame exceeds a given amount of time, and when there is no free space in a buffer, the ownership of the buffer in which the frame has been stored is transferred to the CPU 5, and the next frame is stored in the next buffer, in the present embodiment, even when the free space of a buffer is smaller than the frame length of the next frame, the ownership of the buffer in which the frame has been stored is transferred to the CPU 5, and the next frame is stored in the next buffer.

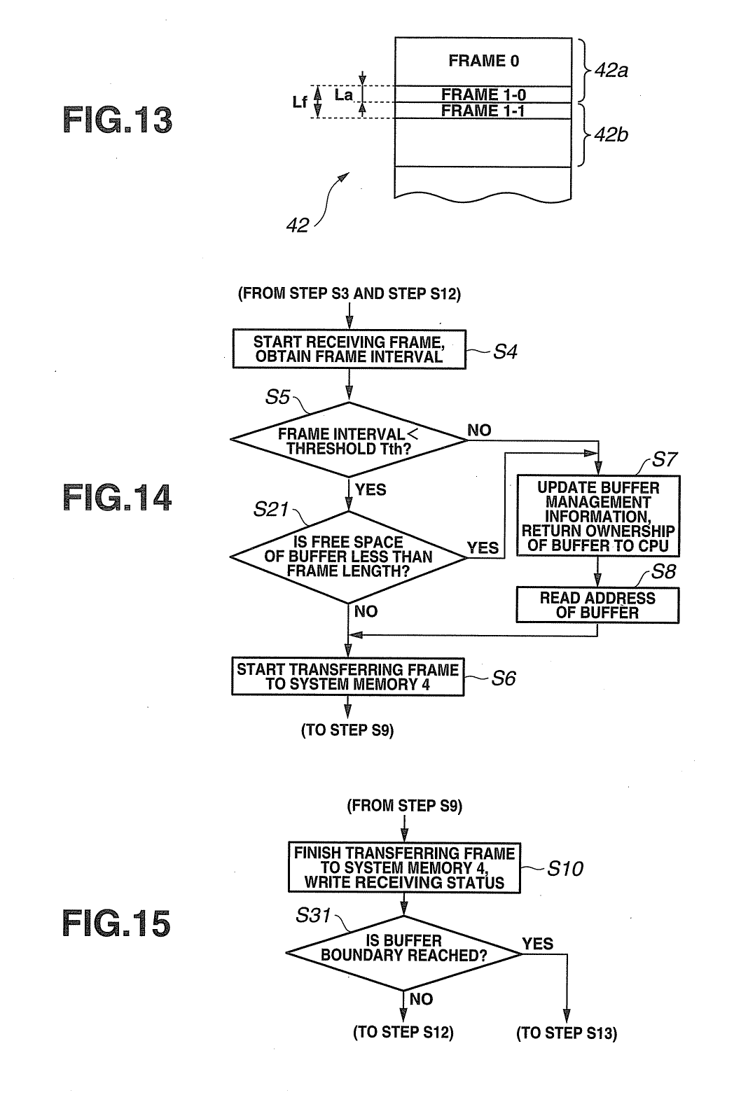

For example, at the point of time when the frame 0 has been stored in the buffer 42a, in a situation where the amount of the free space in the buffer 42a is La, if the frame 1 having a frame length Lf (>La) arrives at the received frame processing device 1 after the reception of the frame 0 has been completed and before a threshold Tth has elapsed, the frame 1 is stored spanning the buffer 42a and the buffer 42b, in the first embodiment described above, as shown in FIG. 13. FIG. 13 is a schematic diagram illustrating an example in which a received frame is stored spanning a plurality of buffers.

When the frame 1 has been stored spanning a plurality of buffers 42a and 42b as shown in FIG. 13, more specifically, when a frame 1-0, which is a portion of the frame 1, has been stored in the buffer 42a, and a frame 1-1, which is the remaining portion of the frame 1, has been stored in the buffer 42b, even if the ownership of the buffer 42a is transferred to the CPU 5 at the point of time when the frame 1 has been received, the CPU 5 cannot handle the whole of the frame 1 because the ownership of the buffer 42b is held by the received frame processing device. Accordingly, the latency of a frame stored spanning a plurality of buffers like the frame 1 is larger than a frame stored in one buffer.

Further, since the CPU 5 obtains the addresses of all buffers in which the frame has been stored, and constructs connection in order to handle the whole of the frame stored spanning a plurality of buffers, a processing load is increased.

Then, in the present embodiment, when the free space of a buffer in which the next frame is to be stored is smaller than the frame length of the next frame, by switching the storage destination of the frame to the next buffer, the ratio at which the frame is stored spanning a plurality of buffers is reduced.

Since the configuration of a received frame processing device in the present embodiment is the same as that of the received frame processing device 1 of the first embodiment, which was described with reference to FIG. 1, only a received frame processing method will be described herein, and the description of the same components to which the like symbols are assigned will be omitted.

In the received frame processing method of the first embodiment, which was described with reference to FIG. 6, after frame reception is started (steps S4), and a frame interval is compared with the threshold Tth (step S5), a frame is transferred to a buffer in which the frame is to be stored when the frame interval is less than the threshold Tth (step S6).

On the other hand, in the present embodiment, as shown in FIG. 14, after the frame interval is compared with the threshold Tth (step S5), and the free space of the buffer is compared with the frame length of a frame that is being received (step S21), the frame is transferred to a buffer in which the frame is to be stored only when the free space of the buffer is larger than the frame length (step S6). FIG. 14 is a flowchart illustrating the processing procedure of a received frame according to the second embodiment of the present invention.

In step S21, when it is determined that the free space of the buffer is less than the frame length, just as in the case of the frame interval being equal to or larger than the threshold Tth, the process goes to step S7, where the necessary portions of the buffer management information are updated, and the ownership is returned to the CPU 5. Then, the process goes to step S8, where the next buffer management information from the buffer management information group 41 in the system memory 4 is referred to obtain the address of the corresponding buffer, then the process goes to step S6.

In this manner, in the present embodiment, when the frame length of a frame that is being received is larger than the free space of a buffer in which the frame is to be stored, by switching the storage to the next buffer, the ratio at which a frame is stored spanning a plurality of buffers can be reduced, reducing the latency of the frame, and the processing load of the CPU.

### Three Embodiment

Next, a received frame processing device according to a third embodiment of the present invention will be concretely described.

Although in the first embodiment described above, when the frame interval between one frame and the next frame exceeds a given amount of time, and when there is no free space La in a buffer, the ownership of the buffer in which the frame has been stored is transferred to the CPU 5, and the next frame is stored in the next buffer, in the present embodiment, even when the free space La of the buffer is less than the minimum frame size Lmin according to the specification of the network standard, the ownership of the buffer in which the frame has been stored is transferred to the CPU 5, and the next frame is stored in the next buffer.

When the free space La of a buffer is less than the minimum frame size Lmin according to the specification of the network standard at the point of time when one frame has been stored in the buffer, and the frame interval between the frame and the next frame is less than the threshold Tth, in the first embodiment, the next frame is stored in the buffer in the packing mode, therefore, the next frame is stored spanning the buffer and the next buffer regardless of the frame length. The latency of the frame stored spanning a plurality of buffers is larger than the latency of a frame stored in one buffer, thus the processing load of a CPU is increased.

Then, in the present embodiment, when the free space of a buffer in which the next frame is to be stored is smaller than the minimum frame size Lmin according to the specification of the network standard, by switching the storage destination of the frame to the next buffer, the ratio at which the frame is stored spanning a plurality of buffers is reduced.

Since the configuration of a received frame processing device in the present embodiment is the same as the received frame processing device 1 of the first embodiment, which was described with reference to FIG. 1, only a received frame processing method will be described herein, and the description of the same components to which the like symbols are assigned will be omitted.

In the received frame processing method of the first embodiment, which was described with reference to FIG. 6, after frame transfer to a suitable buffer in the system memory 4 has finished, and receiving status has been written into buffer management information corresponding to the buffer in which the frame has been stored (step S10), it is determined whether or not there is free space in the buffer into which the frame has been written (step S11), and if it is determined that the buffer boundary is not reached and there is free space in the buffer, the arrival of the next frame is waited for (step S12).

On the other hand, in step S11, when it is determined the buffer boundary is reached, and there is not free space in the buffer, the process goes to step S13, where the necessary portions of the buffer management information corresponding to the buffer are updated, and the ownership is returned to the CPU 5. Then, the process returns to step S2, where the next buffer management information from the buffer management information group 41 in the system memory 4 is referred to obtain the address of the corresponding buffer, and the arrival of the next frame is waited for.

On the other hand, in the present embodiment, as shown in FIG. 15, after frame transfer to the buffer has finished, and the receiving status has been written into the buffer management information (step S10), it is determined whether or not there is free space in the buffer into which the frame has been written, and the free space La of the buffer is less than the minimum frame size Lmin (step S31). When it is determined that the buffer boundary is not reached, and there is free space equal to or larger than the minimum frame size Lmin in the buffer, the arrival of the next frame is waited for (step S12). FIG. 15 is a flowchart illustrating the processing procedure of a received frame according to the third embodiment of the present invention.

In step S31, when it is determined that there is no free space in the buffer into which the frame has been written (=buffer boundary is reached), or the free space La of the buffer is less than the minimum frame size Lmin, the process goes to step S13, where the necessary portions of the buffer management information corresponding to the buffer are updated, and the ownership is returned to the CPU 5. Then, the process returns to step S2, where the next buffer management information from the buffer management information group 41 in the system memory 4 is referred to obtain the address of the corresponding buffer, and the arrival of the next frame is waited for.

In this manner, in the present embodiment, when the free space of a buffer in which a frame has been stored is smaller than the minimum frame size according to the specification of the network standard, by switching the storage destination of the next frame to the next buffer, the ratio at which a frame is stored spanning a plurality of buffers can be reduced, allowing the latency of the frame to be reduced, and the processing load of the CPU to be reduced.

Further, after the frame is stored in the buffer, the free space La of the buffer in which the frame has been stored is immediately compared with the minimum frame size Lmin according to the specification of the network standard, and when La<Lmin, by switching the storage destination of the next frame to the next buffer to wait for the arrival of the next frame, the ownership of the buffer in which the frame has been stored is returned to the CPU quickly, thereby further reducing the latency of the frame.

### Fourth Embodiment

Next, a received frame processing device according to a fourth embodiment of the present invention will be concretely described.

Although, in the first embodiment described above, timing of generation of an interrupt from the received frame processing device 1 with respect to the CPU 5 has not been described clearly, usually an interrupt is generated at the point of time when the reception of one frame has been completed, or transfer of one frame to the system memory 4 has been completed. In the present embodiment, an interrupt is generated at the point of time when the ownership of one buffer has been transferred from the received frame processing device to the CPU 5.

When a buffer is managed in the packing mode, even if an interrupt is generated at the point of time when the reception of one frame has been completed, or at the point of time when writing into a buffer has been completed, the ownership of the buffer has not been transferred to the CPU 5, therefore, the entire frame that generated the interrupt cannot be handled. However, when an interrupt is generated, since the CPU 5 must respond thereto, the CPU 5 is caused to perform useless processing, resulting in increasing the processing load.

Further, if interrupts are generated on a frame unit basis, when the frequency of frame arrival is high, the frequency of interrupt generation is also increased. Then, the processing load of the CPU 5 is also increased as the number of interrupts is increased.

Therefore, in the present embodiment, by generating interrupts on a buffer unit basis, not on a frame unit basis, (an interrupt is generated at the point of time when the ownership of a buffer has been transferred to the CPU 5), the generation of an interrupt for which the entire frame cannot be handled even if the CPU 5 responds (hereinafter referred to as useless interrupt) is suppressed, and the processing load of the CPU 5 is reduced.

Since the configuration of a received frame processing device in the present embodiment is the same as that of the received frame processing device 1 of the first embodiment, which was described with reference to FIG. 1, only a received frame processing method will be described herein, and the description of the same components to which the like symbols are assigned will be omitted.

In the received frame processing method in the present embodiment, in steps S7 and S13 of the received frame processing method of the first embodiment, which was described with reference to FIG. 6, after the ownership of the buffer is returned to the CPU 5, an interrupt is caused to be generated at the CPU 5 through an interrupt controller from an interrupt control unit 16.

In the example of FIG. 7, when interrupts are generated on a frame unit basis, an interrupt is generated at the point of time when four frames, frames 0 to 3, have been stored in the buffers 42a to 42d, respectively. This causes a total of four interrupts to be generated.

When all frames are stored in buffers in the unpacking mode, the number of invalid interrupts is zero. However, when all frames are stored in buffers in the packing mode, interrupts generated at the point of time when frames 0 to 2 have been stored are invalid interrupts because the ownership of the buffer 42a has not been transferred yet to the CPU 5, and each frame cannot be handled. That is to say, among a total of four interrupts, three interrupts are invalid interrupts.

In contrast to this, in the present embodiment, in the example of FIG. 7, interrupts are generated at the point of time when the ownership of the buffer 42a in which the frame 0 has been stored has been returned to the CPU 5 (=t_{0be} in FIG. 12), at the point of time when the ownership of the buffer 42b in which the frames 1 and 2 have been stored has been returned to the CPU 5 (=t_{2be} in FIG. 12), and at the point of time when the ownership of the buffer 42c in which the frame 3 has been stored has been returned to the CPU 5 (=t_{3be} in FIG. 12).

This causes a total of three interrupts to be generated, among which none is an invalid interrupt. That is to say, the number of interrupt generations can be reduced by one, and no useless interrupt is generated even if frames are stored in the packing mode like the buffer 42b.

In this manner, in the present embodiment, by generating interrupts on a buffer unit basis, the number of interrupt generations and the generation of a useless interrupt can be suppressed, and the processing load of the CPU 5 can be reduced. Further, since suppressing the number of interrupt generations reduces the occupancy of the CPU 5, to allow the CPU to perform other processing, the effect of improvement of the processing efficiency of the CPU 5 can also be expected.

### Fifth Embodiment

Next, a received frame processing device according to a fifth embodiment of the present invention will be concretely described.

Although, in the fourth embodiment described above, an interrupt is generated every time the ownership of one buffer is returned to the CPU 5, in the present embodiment, an interrupt is generated at the point of time when the ownerships of a prescribed number of buffers, which is equal to or more than two, have been returned to the CPU 5. Accordingly, an effect of further reducing the processing load of the CPU 5 can be expected when the frequency of frame reception is high.

In the received frame processing method of the fourth embodiment, which was described with reference to FIG. 6, in steps S7 and S13, after the ownership of the buffer is returned to the CPU 5, an interrupt is caused to be generated at the CPU 5 through the interrupt controller from the interrupt control unit 16, each process goes to step S8 and step S2, where the address of a buffer in which a frame is to be stored is read out from the buffer management information.

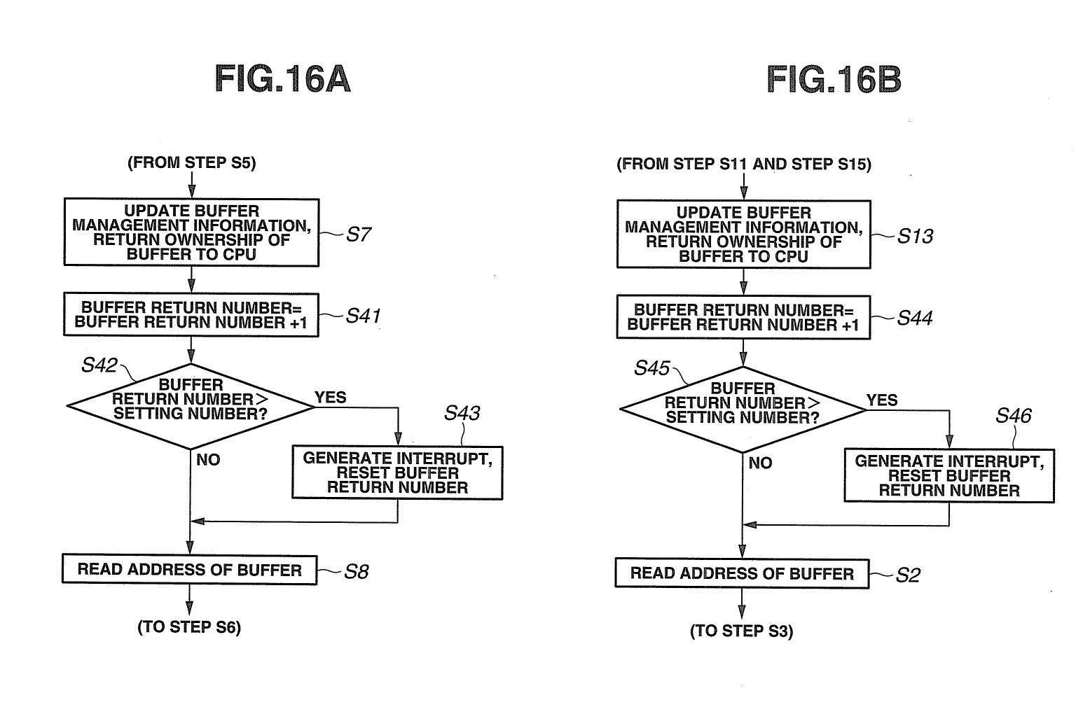

On the other hand, in the present embodiment, as shown in FIGS. 16A and 16B, in steps S7 and S13, after the ownership of the buffer is returned to the CPU 5, one is added to the number of buffers that returned the ownership to the CPU 5 (hereinafter referred to as buffer return number) (steps S41 and S44). FIGS. 16A and 16B are flowcharts illustrating the processing procedure of a received frame according to the fifth embodiment of the present invention. Here, the buffer return number is the number of buffers that returned the ownership to the CPU 5 after the generation of the previous interrupt, and is measured by the counter 21, for example.

In the subsequent step S42 or step S45, when the buffer return number is larger than a setting number, each process goes to steps S43 and S46, where an interrupt is caused to be generated at the CPU 5 through the interrupt controller from the interrupt control unit 16, and the buffer return number is reset, and each process goes to steps S8 and S2, where the address of a buffer in which a frame is to be stored is read from the buffer management information.

On the other hand, in step S42 or step S45, when the buffer return number is equal to or less than the setting number, no interrupt is generated, and each process goes to steps S8 and S2, where the address of a buffer in which a frame is to be stored is read from the buffer management information.

Note that, a setting number, that is to say, the number of buffers at which an interrupt is to be generated, can be set to a value adapted to a system during configuration of the received frame processing device or at a register unit 15.

In this manner, in the present embodiment, by generating an interrupt when the ownerships of a plurality of buffers are returned to the CPU 5, the number of interrupt generations can be further suppressed, and the processing load of the CPU 5 can be further reduced. Furthermore, further suppressing the number of interrupt generations reduces the occupancy of the CPU, allowing the CPU to perform other processing, the effect of improvement of the processing efficiency of the CPU 5 can be further expected.

### Sixth Embodiment

Next, a received frame processing device according to a sixth embodiment of the present invention will be concretely described. Since the configuration of a received frame processing device in the present embodiment is the same as that of the received frame processing device 1 of the first embodiment, which was described with reference to FIG. 1, only a received frame processing method will be described herein, and the description of the same components to which the like symbols are assigned will be omitted.

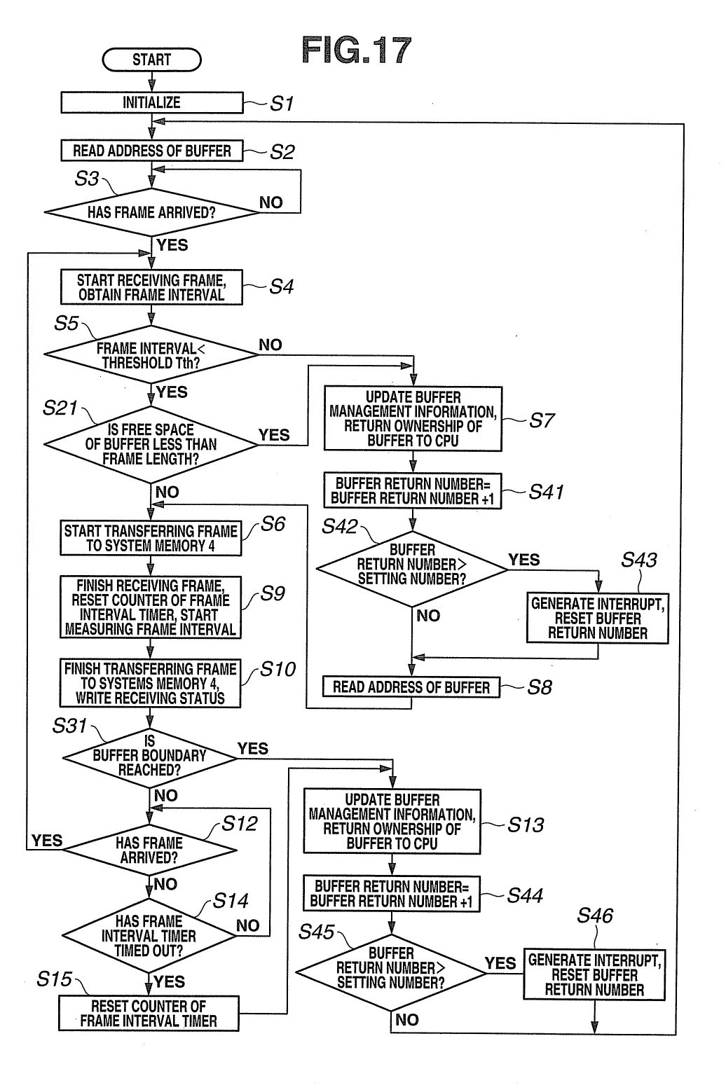

The received frame processing method of the present embodiment is a combination of the first to third and fifth embodiments described above. A concrete method will be described with reference to FIG. 17. FIG. 17 is a flowchart illustrating the processing procedure of a received frame according to the sixth embodiment of the present invention.

First, as with the first embodiment, each portion of the device is initialized (step S1), and the address of a buffer in which a first frame is to be stored is read from the buffer management information (step S2). In the subsequent step S3, when a frame arrives, the frame reception is started, and the frame interval is obtained (step S4).

In the subsequent step S5, when the frame interval is less than a preset threshold, as with the second embodiment, the process goes to step S21, where the free space of the buffer is compared with the frame length of the frame that is being received; when the free space is equal to or larger than the frame length, the process goes to step S6, where the frame transfer is started.

On the other hand, when the frame interval is equal to or larger than the threshold in step S5, or the free space of the buffer is less than the frame length in step S21, the process goes to step S7, where the buffer management information corresponding to the buffer is updated, and the ownership of the buffer is returned to the CPU 5. Then, as with the fifth embodiment, the process goes to step S41, where one is added to the buffer return number, and the buffer return number is compared with a setting number (step S42).

When the buffer return number is larger than the setting number, the process goes to step S43, where an interrupt is generated, and the buffer return number is reset, and the process goes to step S8, where the address of the next buffer that is to be the storage destination of a frame is read. On the other hand, when the buffer return number is equal to or less than the setting number, no interrupt is generated, and the process goes to step S8. Then, the process goes to step S6, and frame transfer is started.

As with the first embodiment, after the frame transfer is started (step S6), and the frame reception is completed, the counter of the frame interval timer is reset, and the measurement of the frame interval is started immediately (step S9). Then, when the frame transfer has been completed, the receiving status or the like is written into the buffer management information (step S10).

Next, as with the third embodiment, the process goes to step S31, where it is determined whether or not there is free space in the buffer into which the frame has been written, and the free space La of the buffer is less than the minimum frame size Lmin. When it is determined that the buffer boundary is not reached, and there is free space equal to or larger than the minimum frame size Lmin in the buffer, the arrival of the next frame is waited for (step S12).

In step S31, when it is determined that there is no free space in the buffer into which the frame has been written (=buffer boundary is reached), or the free space La of the buffer is less than the minimum frame size Lmin, the process goes to step S13, where the necessary portions of the buffer management information corresponding to the buffer are updated, and the ownership is returned to the CPU 5.

Then, as with the fifth embodiment, the process goes to step S44, where one is added to the buffer return number, and the buffer return number is compared with a setting number (step S45). When the buffer return number is larger than the setting number, the process goes to step S46, where an interrupt is generated, and the buffer return number is reset, and the process goes to step S2, where the address of the next buffer that is to be the storage destination of a frame is read. On the other hand, when the buffer return number is equal to or less than the setting number, no interrupt is generated, and the process goes to step S2.

Subsequently, as with the first embodiment, in step S12, when a frame arrives, the process returns to step S4, where the frame reception is started. On the other hand, when no frame arrives, the process goes to step S14, where it is determined whether or not a frame interval timer, which started measurement in step S9, has timed out.

In step S14, when it is determined that the frame interval timer has not timed out, the process returns to step S12, where the arrival of the next frame is waited for. On the other hand, in step S14, when it is determined that the frame interval timer has timed out, the process goes to step S15, where the counter for the frame interval timer is reset by the main control unit 13. Then, the process goes to step S13, where the necessary portions of the buffer management information corresponding to the buffer are updated, and the ownership is returned to the CPU 5.

While the received frame processing device 1 is operating, the process of each step described above is repeatedly performed, and the frames received from the network 2 are written into suitable buffers in the buffer group 42 in the system memory 4.

In this manner, in the present embodiment, combining the first to third and fifth embodiments accumulate the effects of each, and in particular, further reduces the processing load of the CPU.

According to the embodiment described above, memory usage efficiency can be improved, the latency of the frame can be reduced, and the CPU load can also be reduced.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A received frame processing device that receives a frame of variable length from a network, and transfers the frame to a buffer area that is provided on a system memory and is a common area to a CPU, wherein
the buffer area comprises a plurality of buffers, and a second frame is transferred to a first buffer when the second frame is received before a given amount of time has elapsed after a first frame has been transferred to the first buffer, on the other hand, the second frame is transferred to a second buffer after the ownership of the first buffer has been transferred to the CPU when the second frame is received after the first frame has been transferred to the first buffer and after a given amount of time or longer has elapsed.

2. The received frame processing device according to claim 1, wherein when the free space of the first buffer after the first frame has been stored therein is less than the length of the second frame, the second frame is transferred to the second buffer after the ownership of the first buffer has been transferred to the CPU.

3. The received frame processing device according to claim 2, wherein when the free space of the first buffer after the first frame has been stored therein is less than the minimum length of a frame according to the specification of the standard of the network, the second frame is transferred to the second buffer after the ownership of the first buffer has been transferred to the CPU.

4. The received frame processing device according to claim 2, wherein an interrupt is generated at the point of time when the ownerships of a given number of the buffers have been transferred to the CPU.

5. The received frame processing device according to claim 3, wherein an interrupt is generated at the point of time when the ownerships of a given number of the buffers have been transferred to the CPU.

6. The received frame processing device according to claim 1, wherein when the free space of the first buffer after the first frame has been stored therein is less than the minimum length of a frame according to the specification of the standard of the network, the second frame is transferred to the second buffer after the ownership of the first buffer has been transferred to the CPU.

7. The received frame processing device according to claim 6, wherein an interrupt is generated at the point of time when the ownerships of a given number of the buffers have been transferred to the CPU.

8. The received frame processing device according to claim 1, wherein an interrupt is generated at the point of time when the ownerships of a given number of the buffers have been transferred to the CPU.

9. A received frame processing system, comprising:
a CPU;
a system memory; and
a network controller configured to receive a frame of variable length from a network, and transfer the frame to a buffer area that is provided on the system memory through a system bus, and is a common area to the CPU,
wherein the buffer area comprises a plurality of buffers, and a second frame is transferred to a first buffer when the second frame is received before a given amount of time has elapsed after a first frame has been transferred to the first buffer, on the other hand, the second frame is transferred to a second buffer after the ownership of the first buffer has been transferred to the CPU when the second frame is received after the first frame has been transferred to the first buffer and after a given amount of time or longer has elapsed.

10. The received frame processing system according to claim 9, wherein when the free space of the first buffer after the first frame has been stored therein is less than the length of the second frame, the second frame is transferred to the second buffer after the ownership of the first buffer has been transferred to the CPU.

11. The received frame processing system according to claim 9, wherein when the free space of the first buffer after the first frame has been stored therein is less than the minimum length of a frame according to the specification of the standard of the network, the second frame is transferred to the second buffer after the ownership of the first buffer has been transferred to the CPU.

12. The received frame processing system according to claim 10, wherein when the free space of the first buffer after the first frame has been stored therein is less than the minimum length of a frame according to the specification of the standard of the network, the second frame is transferred to the second buffer after the ownership of the first buffer has been transferred to the CPU.

13. The received frame processing system according to claim 9, wherein an interrupt is generated at the point of time when the ownerships of a given number of the buffers have been transferred to the CPU.

14. The received frame processing system according to claim 12, wherein an interrupt is generated at the point of time when the ownerships of a given number of the buffers have been transferred to the CPU.

15. A received frame processing method that receives a frame of variable length from a network, and transfers the frame to a buffer area that is provided on a system memory, is a common area to a CPU, and comprises a plurality of buffers, comprising:
transferring a first frame to a first buffer;
starting the count of a frame interval counting timer at the point of time when the reception of the first frame has been completed;
transferring a second frame to the first buffer when the second frame is received before the count of the frame interval counting timer reaches a predetermined value; and
transferring the second frame to a second buffer after the ownership of the first buffer has been transferred to the CPU when the second frame is received after the count of the frame interval counting timer reaches a predetermined value or higher.

16. The received frame processing method according to claim 15, wherein when the free space of the first buffer after the first frame has been stored therein is less than the length of the second frame, the second frame is transferred to the second buffer after the ownership of the first buffer has been transferred to the CPU.

17. The received frame processing method according to claim 15, wherein when the free space of the first buffer after the first frame has been stored therein is less than the minimum length of a frame according to the specification of the standard of the network, the second frame is transferred to the second buffer after the ownership of the first buffer has been transferred to the CPU.

18. The received frame processing method according to claim 16, wherein when the free space of the first buffer after the first frame has been stored therein is less than the minimum length of a frame according to the specification of the standard of the network, the second frame is transferred to the second buffer after the ownership of the first buffer has been transferred to the CPU.

19. The received frame processing method according to claim 15, wherein an interrupt is generated at the point of time when the ownerships of a given number of the buffers have been transferred to the CPU.

20. The received frame processing method according to claim 18, wherein an interrupt is generated at the point of time when the ownerships of a given number of the buffers have been transferred to the CPU.
